(19) United States
(12) Patent Application Publication
(10) Pub. No.: US 2025/0153972 A1
(43) Pub. Date: May 15, 2025

(54) ELEVATOR CONTROL SYSTEM

(71) Applicant: Mitsubishi Electric Corporation, Tokyo (JP)

(72) Inventors: Hidetaka ISHIGURO, Tokyo (JP); Hirokazu BANNO, Tokyo (JP)

(73) Assignee: Mitsubishi Electric Corporation, Tokyo (JP)

(21) Appl. No.: 18/728,136

(22) PCT Filed: Jan. 28, 2022
(86) PCT No.: PCT/JP2022/003244

§ 371 Date: Jul. 11, 2024

(51) Int. Cl. B66B 3/02; B66B 1/34; B66B 1/36; B66B 5/02

(52) U.S. Cl. CPC B66B 3/023; B66B 1/3492; B66B 1/36; B66B 5/02

(57) ABSTRACT

In a control system, a code tape is placed in a hoistway with its vertical end parts serving as a fixed end and a movable end. A reader installed in a car reads information indicating a longitudinal position added to the code tape. A detection device detects that the car is in a reference position when a detection switch installed in the reference position on the movable end side of the hoistway detects a detection target cam installed in the car. A controller performs control processing using the position read by the reader as an absolute position of the car. The controller corrects the absolute position of the car using the longitudinal position read by the reader at the time of detection by the detection device.

### TECHNICAL FIELD

The present disclosure relates to an elevator control system.

### BACKGROUND ART

Patent Literature 1 discloses an example of an elevator. In the elevator, a magnetic tape is placed in a hoistway. A car position detection device detects the position of a car in the hoistway by reading data on the magnetic tape with a magnetic sensor. In the adjustment of the car position detection device, the car is moved to the top floor and the bottom floor by manual operation, and data on positions of the top floor and the bottom floor are read. Preset positions of the floors are corrected on the basis of an error between the read data and preset design positions of the bottom floor and the top floor.

### CITATION LIST

### Patent Literature

[PTL 1] JP 2015-113180 A

### SUMMARY OF THE INVENTION

### Problem to be Solved by the Invention

However, the length of a code tape used for car position detection such as the magnetic tape placed in the hoistway may change over time due to expansion or contraction caused by a temperature change in the hoistway, for example. In the elevator of Patent Literature 1, the car position corresponding to each floor adjusted by the manual operation may be shifted largely by temporal change.

The present disclosure relates to a solution to such a problem. The present disclosure provides an elevator control system that can curb the effect of positional deviation of the car even in a case where the length of a code tape changes over time.

### Means to Solve the Problem

An elevator control system according to the present disclosure includes: a code tape on which information indicating a longitudinal position is added over a longitudinal direction, placed such that the longitudinal direction is oriented in a vertical direction in a hoistway extending over a plurality of floors of a building, and including one end part in the vertical direction installed so as to be fixed to the hoistway as a fixed end and another end part in the vertical direction installed so as to be movable in the vertical direction relative to the hoistway as a movable end; a reader that is installed in a car running through the hoistway in the vertical direction, and reads the information indicating the longitudinal position added to the code tape; a detection device that includes a detection target body and a detector detecting the detection target body, one of the detection target body and the detector being installed in the car, another of the detection target body and the detector being installed in a reference position set in advance on the movable end side in the vertical direction of the hoistway, the detector detecting the detection target body to detect that the car is in the reference position; and a controller that performs control processing of the car by using the longitudinal position read by the reader as an absolute position of the car in the vertical direction in the hoistway, and corrects the absolute position of the car by using the longitudinal position read by the reader when the detection device detects that the car is in the reference position.

### Advantageous Effect of the Invention

The elevator control system according to the present disclosure can curb the effect of positional deviation of the car even in a case where the length of a code tape changes over time.

### BRIEF DESCRIPTION OF DRAWINGS

FIG. 1 is a configuration diagram of an elevator according to Embodiment 1.

FIG. 2 is a flowchart illustrating an example of an operation of the control system according to Embodiment 1.

FIG. 3 is a hardware configuration diagram of a main part of the control system according to Embodiment 1.

### DESCRIPTION OF EMBODIMENT

A mode for implementing the object of the present disclosure will be described with reference to the accompanying drawings. In the drawings, the same or corresponding parts are assigned the same reference signs and redundant description is appropriately simplified or omitted. Note that the object of the present disclosure is not limited to the following embodiment, and any component of the embodiment may be deformed or omitted without departing from the scope of the present disclosure.

### Embodiment 1

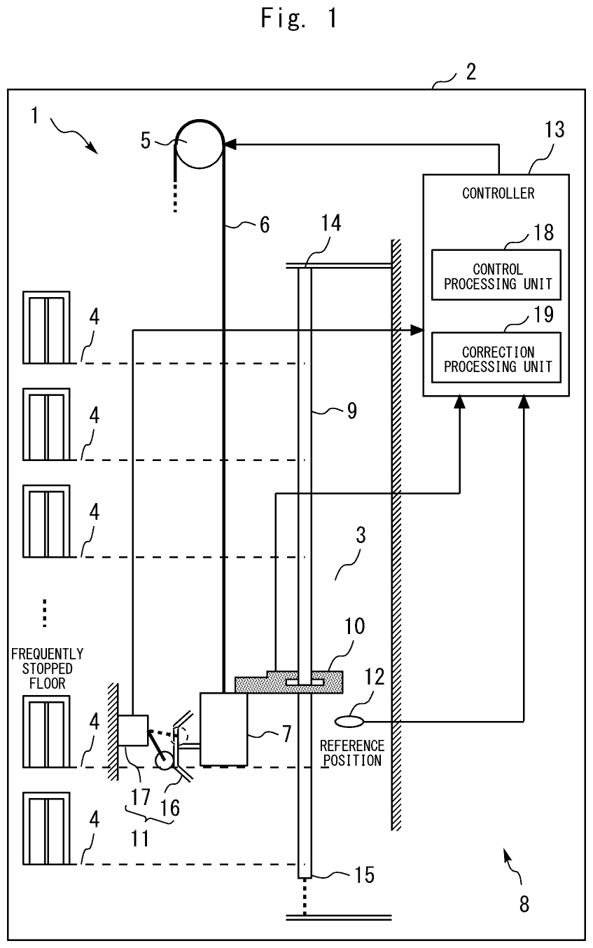

FIG. 1 is a configuration diagram of an elevator 1 according to Embodiment 1.

The elevator 1 is applied to a building 2 that has a plurality of floors, for example. In the building 2, a hoistway 3 of the elevator 1 is provided. The hoistway 3 is a vertically long space extending over the plurality of floors. A hall 4 of the elevator 1 is provided in each floor of the building 2. The hall 4 is a place adjacent to the hoistway 3. The elevator 1 includes a traction machine 5, a main rope 6, a car 7, and a control system 8.

The traction machine 5 includes a motor and a sheave. The traction machine 5 is provided in an upper part or a lower part of the hoistway 3, for example. When a machine room of the elevator 1 is provided in the upper part of the hoistway 3, the traction machine 5 may be placed in the machine room, for example. The motor of the traction machine 5 is a device for generating a drive force. The sheave of the traction machine 5 is connected to a rotation shaft of the motor of the traction machine 5. The sheave of the traction machine 5 is rotated by the drive force generated by the motor of the traction machine 5.

The main rope 6 is wound around the sheave of the traction machine 5. The main rope 6 moves so as to be hoisted up or reeled out by rotation of the sheave of the traction machine 5. The main rope 6 supports the load of the car 7 on one side of the sheave of the traction machine 5.

The car 7 is placed in the hoistway 3. The car 7 runs through the hoistway 3 in the vertical direction when the traction machine 5 moves the main rope 6. The car 7 is a device that transports passengers among the plurality of floors by running through the hoistway 3 in the vertical direction. A stop position is set in each floor. A stop position of a floor of the building 2 is a position on the floor in the vertical direction of the building 2 where the car 7 is to be stopped.

The control system 8 includes a code tape 9, a reader 10, a detection device 11, a temperature sensor 12, and a controller 13.

The code tape 9 is a tape-shaped equipment long in one direction. On the code tape 9, information indicating positions in the longitudinal direction of the code tape 9 is added over the longitudinal direction. In a case where the code tape 9 is a magnetic tape, for example, information indicating a longitudinal position is added to the code tape 9 as magnetic data. Alternatively, information indicating a longitudinal position may be added to a surface of the code tape 9 as a coded image or the like including a two-dimensional code, for example. The code tape 9 is placed in the hoistway 3 such that the longitudinal direction is oriented in the vertical direction. One end part in the vertical direction of the code tape 9 is installed so as to be fixed to the hoistway 3 as a fixed end 14. In addition, the other end part in the vertical direction of the code tape 9 is installed so as to be movable in the vertical direction relative to the hoistway 3 as a movable end 15. In this example, an upper end part of the code tape 9 is installed as the fixed end 14. In this example, the fixed end 14 is directly attached to the structure of the building 2. The structure of the building 2 includes an inner wall of the hoistway 3, a column, a beam, or the like, for example. In addition, a lower end part of the code tape 9 is installed as the movable end 15. The movable end 15 is installed via a spring to be able to give tension to the code tape 9, for example. Alternatively, the movable end 15 may be supported by a slide bearing or the like to be slidable in the vertical direction.

The reader 10 is a device that reads information indicating a longitudinal position added to the code tape 9. The reader 10 is installed in the car 7. The reader 10 moves in the vertical direction in the hoistway 3 together with the car 7. The reader 10 reads information of a longitudinal position from the code tape 9 with a magnetic sensor, a camera, other equipment, or the like, for example. The reader 10 is connected to the controller 13 so as to be able to output the read result.

In the control system 8, a reference position is set in advance. The reference position is set on the movable end 15 side in the vertical direction of the hoistway 3. The reference position is a vertical position in the building 2. In this example, the lower end part of the code tape 9 is installed as the movable end 15, and therefore the reference position is set on the lower side of the hoistway 3. The reference position is set lower than a middle part of the hoistway 3, for example. The reference position is set in the vicinity of a frequently stopped floor, for example. Here, a frequently stopped floor is a floor set in advance as a floor where the car 7 stops more frequently than other floors. For example, a frequently stopped floor is a floor or the like where the car 7 stops more frequently than the average stop frequency of the floors in the building 2. A frequently stopped floor is a reference floor, a main entrance floor, a lobby floor, a ground floor, or the like of the building 2. A frequently stopped floor may be a floor or the like where a front desk is provided, for example. For example, the vicinity of a frequently stopped floor is a range from a stop position of the car 7 on a frequently stopped floor to a stop position of the car 7 on a floor adjacent to the frequently stopped floor. Here, the range may include the stop position on the frequently stopped floor. The reference position may be set at the stop position of the frequently stopped floor.

The detection device 11 includes a detection target body and a detector. The detector is equipment for detecting the detection target body. One of the detection target body and the detector is installed in the car 7. The other of the detection target body and the detector is installed in the reference position in the hoistway 3. One of the detection target body and the detector, which is installed in the car 7, moves through the hoistway 3 in the vertical direction along with the running of the car 7. The detection device 11 detects that the car 7 is in the reference position when the detector detects the detection target body. The detector is connected to the controller 13 so as to be able to output the detection result. In this example, the detection device 11 includes a detection target cam 16 and a detection switch 17. The detection target cam 16 is an example of a detection target body. The detection target cam 16 is installed in the car 7. The detection switch 17 detects the detection target cam 16 by contact when the car 7 runs through the reference position. The detection switch 17 is an example of a detector. The detection switch 17 is installed in the reference position. In this example, the detection switch 17 is directly attached to the structure of the building 2. Note that the detection device 11 may include a detector that detects the detection target body in a noncontact manner. For example, the detection device 11 may include, as the detection target body and the detector, an iron plate and a magnetic sensor, a light reflection plate and a photoelectric sensor, a marker and a camera, or the like. Moreover, the detection target body may be installed in the reference position. At this time, the detection target body is directly attached to the structure of the building 2, for example. In addition, the detector is installed in the car 7. In this example, the control system 8 includes only one set of the detection target body and the detector of the detection device 11.

The temperature sensor 12 is placed in the hoistway 3. The temperature sensor 12 measures the temperature inside the hoistway 3. The temperature sensor 12 is connected to the controller 13 so as to be able to output the measurement result.

The controller 13 is, for example, a control panel or the like of the elevator 1. The controller 13 is provided in the upper part or the lower part of the hoistway 3, for example. For example, when the machine room of the elevator 1 is provided in the upper part of the hoistway 3, the controller 13 may be placed in the machine room. The controller 13 is connected to the traction machine 5 so as to be able to communicate a control signal or the like. The controller 13 includes a control processing unit 18 and a correction processing unit 19.

The control processing unit 18 is a part equipped with a function of performing control processing of the elevator 1. Control processing includes motion control, safety monitoring, or the like of the elevator 1. Motion control of the elevator 1 includes control or the like of running and stopping of the car 7, for example. Safety monitoring of the elevator 1 includes, for example, terminal speed monitoring including an emergency terminal speed-limiting device, and motion control of the elevator 1 based on monitoring of a safety device such as a final limit switch, an open-door running (unintended car movement) protection device, and the like and the result of the monitoring. In this example, an absolute position of the car 7 is detected on the basis of a longitudinal position on the code tape 9 read from the code tape 9 by the reader 10. That is, the control processing unit 18 performs control processing of the elevator 1 by using a longitudinal position read from the code tape 9 as the absolute position of the car 7 in the vertical direction of the hoistway 3.

The correction processing unit 19 is a part equipped with a function of correcting the absolute position of the car 7. The correction processing unit 19 corrects the absolute position of the car 7 when the detection device 11 detects that the car 7 is in the reference position, for example. The correction processing unit 19 calculates a correction coefficient C by the following expression (1), for example.

$$[ Math . 1 ]$$

$$C = \frac{{x}_{0} - {x}_{*}}{{y}_{0} - {y}_{*}} \qquad ( 1 )$$

Here, y₀ represents the longitudinal position of the fixed end 14 of the code tape 9. Then, y* represents the longitudinal position of the code tape 9 read by the reader 10 when the detection device 11 detects that the car 7 is in the reference position. That is, y₀-y* represents a length on the code tape 9 from the fixed end 14 to a part where the reader 10 reads information indicating the longitudinal position when the detection device 11 detects that the car 7 is in the reference position. In addition, x₀ represents the installation position of the fixed end 14 of the code tape 9 in the building 2. Then, x* represents the reference position. That is, x₀-x* represents a length in the building 2 from the installation position of the fixed end 14 to the reference position. The correction coefficient C is calculated as a ratio between these lengths. Note that the position y₀ of the fixed end 14 of the code tape 9 on the code tape 9 and the installation position x₀ of the fixed end 14 of the code tape 9 in the building 2 are preset in the control system 8 by a setting value or the like, for example.

In this example, the correction processing unit 19 corrects an absolute position x of the car 7 from a longitudinal position y on the code tape 9 using the following expression (2) and the like.

$$[ Math . 2 ]$$

$$x = {x}_{0} - C ( {y}_{0} - y ) \qquad ( 2 )$$

Here, when a natural number equal to or smaller than the number of floors of the building 2 is n, x(n) represents a stop position on an nth floor of the building 2. The nth floor of the building 2 is a frequently stopped floor or another floor. The stop position x(n) on each floor is preset in the control system 8 by a setting value, adjustment at the beginning of installation, learning, or the like. For example, the control processing unit 18 controls the corrected absolute position x of the car 7 using the nth-floor stop position x(n) as a target position, to thereby stop the car 7 at the stop position of the floor.

Note that the correction processing unit 19 may perform correction not strictly in proportion to the length in the building 2 or the length on the code tape 9. For example, the correction processing unit 19 may perform correction in a stepwise manner according to the length in the building 2 or the length on the code tape 9. Alternatively, in a case where distribution characteristics of the code tape 9 are known, the correction processing unit 19 may perform correction according to the distribution characteristics. Distribution characteristics of the code tape 9 are characteristics indicating the longitudinal distribution of the material, physical property value, dimension, shape, tension, or the like of the code tape 9, for example.

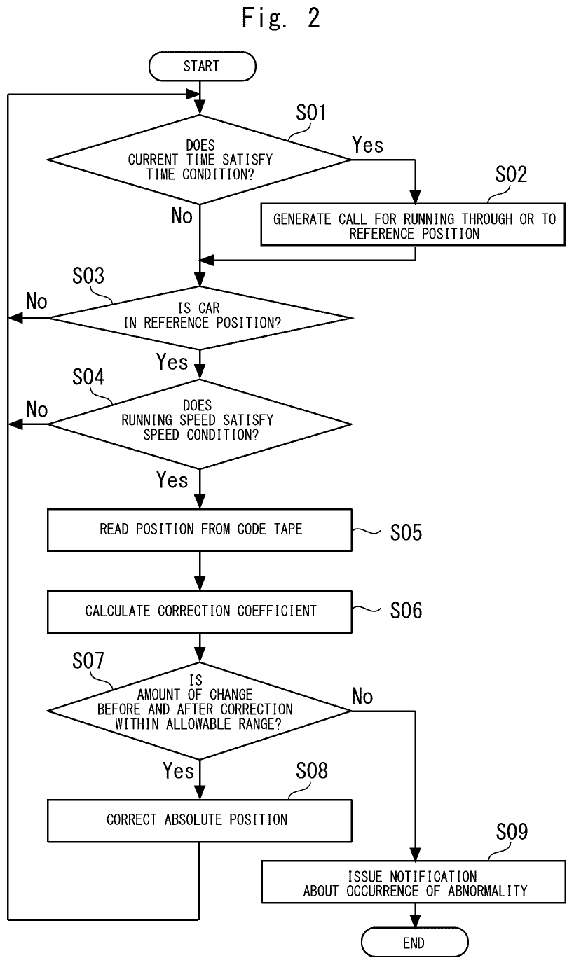

Subsequently, an example of an operation of the control system 8 will be described with reference to FIG. 2.

FIG. 2 is a flowchart illustrating an example of an operation of the control system 8 according to Embodiment 1.

In step S01, the correction processing unit 19 judges whether the current time satisfies a preset time condition. A time condition regarding the current time is a condition such as when the current time matches a preset correction time, for example. The correction time may be a periodically set time. Alternatively, a time condition regarding the current time may be a condition such as when a preset time interval passes from the time of the last correction by the correction processing unit 19, for example. If the current time satisfies the time condition, processing of the control system 8 proceeds to step S02. If the current time does not satisfy the time condition, processing of the control system 8 proceeds to step S03.

In step S02, the control processing unit 18 generates a call for the car 7 to run through or to the reference position. Here, in a case where the reference position is a range from the stop position on a frequently stopped floor to the stop position on an adjacent floor, the call generated by the control processing unit 18 is a call for running in the direction of the adjacent floor from the frequently stopped floor, for example. Alternatively, in a case where the reference position is the stop position on the frequently stopped floor, the call generated by the control processing unit 18 is a call for the car 7 to run to the frequently stopped floor, a call for the car 7 to run through the frequently stopped floor, or the like, for example. The control processing unit 18 causes the car 7 to run through the hoistway 3 so as to respond to a call generated by the control processing unit 18 and a call registered by the user. Thereafter, processing of the control system 8 proceeds to step S03.

Note that when the control processing unit 18 causes the car 7 to respond to the generated call by the control processing unit 18, the control processing unit 18 may cause the car 7 to run by reducing the speed of the car 7, so that the car 7 runs through the reference position at a lower speed than the running speed during normal operation. At this time, the control processing unit 18 may cause the car 7 to respond to the call after confirming that no user is riding the car 7. The fact that no user is riding the car 7 is confirmed on the basis of a load or the like measured by a load weighing device (not illustrated) provided in the car 7, for example.

In step S03, the correction processing unit 19 judges whether the detection device 11 has detected that the car 7 is in the reference position. At this time, the car 7 may be running in response to a call registered by the user. Alternatively, the car 7 may be running in response to a call generated by the control processing unit 18. Alternatively, the car 7 may be running to move to a stand-by position not in response to a call. If the detection device 11 does not detect that the car 7 is in the reference position, processing of the control system 8 proceeds to step S01. If the detection device 11 detects that the car 7 is in the reference position, processing of the control system 8 proceeds to step S04.

In step S04, the correction processing unit 19 judges whether the running speed of the car 7 when the detection device 11 detects that the car 7 is in the reference position satisfies a preset speed condition. A speed condition regarding the running speed of the car 7 is a condition such as when the running speed is lower than a preset speed threshold, for example. Here, the speed threshold is set to such a speed that can reduce an error in reading the absolute position of the car 7 due to the effect of detection delay in the detection device 11 to be equal to or less than an allowable error required as the whole control system 8, for example. The speed threshold is set to a speed lower than the rated running speed between floors during normal operation of the car 7, for example. Alternatively, the speed threshold may be a speed after deceleration when the car 7 decelerates to stop at a frequently stopped floor. In this case, the speed condition is satisfied when the car 7 stops at the frequently stopped floor. If the running speed of the car 7 does not satisfy the speed condition, processing of the control system 8 proceeds to step S01. If the running speed of the car 7 satisfies the speed condition, processing of the control system 8 proceeds to step S05.

In step S05, the reader 10 reads the longitudinal position y* on the code tape 9. The correction processing unit 19 stores the longitudinal position y* on the code tape 9 read by the reader 10. Thereafter, processing of the control system 8 proceeds to step S06.

In step S06, the correction processing unit 19 calculates the correction coefficient C using the expression (1) and the like, for example. Thereafter, processing of the control system 8 proceeds to step S07.

In step S07, the correction processing unit 19 calculates an amount of change in the current absolute position of the car 7 before and after calculation of the correction coefficient C. Alternatively, the correction processing unit 19 may calculate an amount of change in the absolute position of the car 7 corresponding to the stop position on any floor including the frequently stopped floor of the building 2 before and after calculation of the correction coefficient C. For example, the correction processing unit 19 calculates, as the change amount, a difference between the absolute position x of the car 7 obtained by the expression (2) before newly calculating the correction coefficient C in step S06 and the absolute position x of the car 7 obtained by the expression (2) after newly calculating the correction coefficient C in step S06. Note that the correction processing unit 19 may calculate the change amount of the absolute position of the car 7 corresponding to the stop position on another floor. Alternatively, the correction processing unit 19 may calculate the change amount of the absolute position of the car 7 corresponding to the reference position. The correction processing unit 19 judges whether the calculated change amount is within a preset allowable range. Note that the correction processing unit 19 may calculate the change amount for each function of the control processing unit 18 that requires the absolute position of the car 7. In the correction processing unit 19, the allowable range of the change amount may be set for each function of the control processing unit 18 that requires the absolute position of the car 7. For example, regarding the terminal speed monitoring, the change amount or the allowable range of travel may be used for judgement. Alternatively, regarding the open-door running (unintended car movement) protection device, the change amount or the allowable range for the floor closest to the movable end 15 of the code tape 9 may be used for judgement. If the change amount is within the allowable range, processing of the control system 8 proceeds to step S08. If the change amount is not within the allowable range, processing of the control system 8 proceeds to step S09.

In step S08, the correction processing unit 19 corrects the absolute position of the car 7 by updating the correction coefficient C used in the expression (2), for example. Thereafter, processing of the control system 8 proceeds to step S01.

In step S09, the control processing unit 18 judges that an abnormality has occurred in the control system 8. The control processing unit 18 judges that an abnormality has occurred in the code tape 9, for example. The control processing unit 18 may issue a notification about the abnormality that has occurred. The notification is issued to an information center or the like (not illustrated) collecting information of the elevator 1 through a communication network such as the Internet, for example. Alternatively, the notification is issued to a mobile terminal or the like owned by an administrator of the elevator 1 through a communication network such as the Internet, for example. Thereafter, processing of the control system 8 is completed.

As described above, the control system 8 according to Embodiment 1 includes the code tape 9, the reader 10, the detection device 11, and the controller 13. In the code tape 9, information indicating a longitudinal position is added over the longitudinal direction. The code tape 9 is placed such that the longitudinal direction is oriented in the vertical direction in the hoistway 3 extending over the plurality of floors of the building 2. One end part in the vertical direction of the code tape 9 is installed so as to be fixed to the hoistway 3 as the fixed end 14. The other end part in the vertical direction of the code tape 9 is installed so as to be movable in the vertical direction relative to the hoistway 3 as the movable end 15. The reader 10 is installed in the car 7 that runs through the hoistway 3 in the vertical direction. The reader 10 reads information indicating the longitudinal position added to the code tape 9. The detection device 11 includes the detection target cam 16 and the detection switch 17 that detects the detection target cam 16. The detection switch 17 is installed in the car 7. The detection target cam 16 is installed in the reference position. The reference position is a position set in advance on the movable end 15 side in the vertical direction of the hoistway 3. The detection device 11 detects that the car 7 is in the reference position when the detection switch 17 detects the detection target cam 16. The controller 13 performs control processing of the car 7 by using the longitudinal position read by the reader 10 as the absolute position of the car 7 in the vertical direction of the hoistway 3. The controller 13 corrects the absolute position of the car 7 using the longitudinal position read by the reader 10 when the detection device 11 detects that the car 7 is in the reference position.

With such a configuration, the control system 8 can correct the absolute position of the car 7 every time the car 7 runs through or to the reference position. Hence, the effect of positional deviation of the car 7 can be curbed even when the length of the code tape 9 changes over time. The length of the code tape 9 may change over time due to expansion and contraction caused by a temperature change in the hoistway 3, for example. For example, in a case where the elevator 1 is a high-rise elevator with a glass hoistway 3 such as a transparent elevator for observation, the temperature change in the hoistway 3 may become large. With such an elevator 1, temperature change over time of about an hour may become large, and the expansion and contraction of the code tape 9 may become equal to or more than 5 mm in about an hour, for example. In such a case, the effect of expansion and contraction of the code tape 9 becomes too large to ignore. In the control system 8, the absolute position of the car 7 based on information read from the code tape 9 can be corrected when the car 7 runs through or to the reference position. Hence, even when the length of the code tape 9 changes over time, its effect can be curbed by correction. As a result, deviation of the landing position of the car 7 is less likely to occur, and the user can ride the elevator 1 more conveniently. In addition, the detection target body or the detector of the detection device 11 need not be placed for each floor of the building 2. Only one set of the detection target body and the detector of the detection device 11 is necessary. Hence, even in a high-rise elevator 1 that stops at a large number of floors, equipment installation cost and maintenance cost can be reduced.

In addition, in the control system 8, the reference position is set to a range from the stop position of a frequently stopped floor to the stop position of an adjacent floor. Here, the range includes the stop position of the frequently stopped floor. The frequently stopped floor is set in advance as a floor where the car 7 stops more frequently than other floors.

With such a configuration, the car 7 runs through or to the reference position frequently in normal operation. That is, during normal operation, the control system 8 is frequently given a chance to correct the absolute position of the car 7. As a result, even when the length of the code tape 9 changes over time, the effect of positional deviation of the car 7 can be curbed more effectively.

In addition, the controller 13 generates a call for the car 7 to run through or to the reference position when the current time satisfies a preset time condition.

With such a configuration, for example, even when the car 7 is running in a range away from the reference position such as a high zone floor due to a call from the user, the control system 8 is given a chance to correct the absolute position of the car 7 at a preset timing. As a result, it is possible to prevent passage of a long time period without correcting the absolute position. Hence, even when the length of the code tape 9 changes over time, the effect of positional deviation of the car 7 can be curbed more effectively.

Note that the control system 8 may include the temperature sensor 12. The temperature sensor 12 is installed in the hoistway 3. At this time, the control processing unit 18 of the controller 13 may generate a call for the car 7 to run through or to the reference position when the temperature measured by the temperature sensor 12 satisfies a preset temperature condition. The temperature condition regarding the temperature of the hoistway 3 measured by the temperature sensor 12 is a condition such as when the temperature of the hoistway 3 exceeds a preset temperature threshold, or when the temperature of the hoistway 3 falls within a preset temperature range, for example.

With such a configuration, the control system 8 is given a chance to correct the absolute position of the car 7 according to need due to a temperature change in the hoistway 3. As a result, there are less cases where no correction of the absolute position is performed even when there is a temperature change in the hoistway 3. Hence, even when the length of the code tape 9 changes over time, the effect of positional deviation of the car 7 can be curbed effectively. Note that the control system 8 may generate a call on the basis of both the time condition and the temperature condition. The control system 8 may generate a call on the basis of only one of the time condition and the temperature condition. Alternatively, the control system 8 does not have to generate a call based on the time condition or the temperature condition.

In addition, the controller 13 corrects the absolute position of the car 7 corresponding to the stop position on each floor on condition that the speed of the car 7 when running through the reference position is lower than a preset speed threshold. At this time, the controller 13 uses, in the correction, the longitudinal position read by the reader 10 when the detection device 11 detects that the car 7 is in the reference position in a case where the condition is satisfied.

With such a configuration, reading of the absolute position of the car 7 used for correction is less likely to be affected by detection delay in the detection device 11. Hence, information used for correction can be obtained with higher accuracy, and accuracy of the correction can be increased. Note that the controller 13 may correct the absolute position every time the car 7 run through or to the reference position, regardless of the running speed of the car 7.

In addition, the controller 13 calculates, as a correction coefficient, a ratio between a length from the fixed end 14 to a part where the reader 10 reads information indicating the longitudinal position when the detection device 11 detects that the car 7 is in the reference position and a length from the installation position of the fixed end 14 to the reference position. The controller 13 corrects the absolute position of the car 7 by using a value obtained by multiplying a length based on the fixed end 14 by the calculated correction coefficient.

With such a configuration, calculation of a single correction coefficient simplifies correction of the absolute position of the car 7 and the like.

In addition, the controller 13 judges whether the amount of change in the absolute position of the car 7 corresponding to at least one of the stop position of each floor and the reference position before and after correction of the absolute position is within a preset allowable range. If the change amount is within the allowable range, the controller 13 corrects the absolute position of the car 7.

With such a configuration, in the control system 8, abnormality that occurs in the code tape 9 is detected. Since abnormality that occurs in the code tape 9 is more easily dealt with, the elevator 1 is more stably operated.

Note that the correction processing unit 19 of the controller 13 may calculate an error of the absolute position of the car 7 corresponding to the stop position on any floor of the building 2 after calculating the correction coefficient. The correction processing unit 19 calculates a difference between the stop position on a frequently stopped floor and the absolute position of the car 7 corresponding the stop position as an error, for example. Note that the correction processing unit 19 may calculate an error of the absolute position of the car 7 corresponding to the stop position of another floor. Alternatively, the correction processing unit 19 may calculate an error of the absolute position of the car 7 corresponding to the reference position. The correction processing unit 19 judges whether the calculated error is within a preset allowable range. Here, the allowable range set for the error and the amount of change before and after correction of the absolute position of the car 7 may be different from each other or may be similar to each other. In a case where the error is within the allowable range, the controller 13 corrects the absolute position of the car 7. On the other hand, in a case where the error is not within the allowable range, the controller 13 judges that an abnormality has occurred in the control system 8.

With such a configuration, too, in the control system 8, abnormality that occurs in the code tape 9 is detected. Note that the control system 8 may judge whether an abnormality has occurred on the basis of both the change amount and the error of the absolute position of the car 7. The control system 8 may judge whether an abnormality has occurred on the basis of only one of the change amount and the error of the absolute position of the car 7. Alternatively, the control system 8 does not have to judge whether an abnormality has occurred on the basis of the change amount or the error of the absolute position of the car 7.

In addition, the fixed end 14 of the code tape 9 is attached to the structure of the building 2. In the detection device 11, one of the detection target body and the detector, which is installed in the reference position, is attached to the structure of the building 2.

With such a configuration, the installation position of the fixed end 14 of the code tape 9 and the reference position are displaced by shrinkage of the building 2 itself or the like, and therefore the effect of the shrinkage of the building 2 itself or the like is included in the correction of the absolute position of the car 7. As a result, deviation of the landing position of the car 7 and the like is less likely to occur, and the user can ride the elevator 1 more conveniently.

Note that the code tape 9 may be installed in the hoistway 3 with the lower end part used as the fixed end 14. At this time, the code tape 9 is installed in the hoistway 3 with the upper end part used as the movable end 15. In this case, the reference position is set on the upper side of the hoistway 3. In addition, the frequently stopped floor may be set in a transfer floor in an upper part of the hoistway 3, for example.

In addition, in the examples described above, the correction processing unit 19 corrects the absolute position of the car 7 using the correction coefficient C for conversion of the position y on the code tape 9 into the position x in the building 2, but the method of correcting the absolute position of the car 7 is not limited thereto. The correction processing unit 19 may correct the absolute position of the car 7 by updating the target position corresponding to the stop position on each floor by using a correction coefficient C′ as described below, for example. The correction processing unit 19 calculates the correction coefficient C′ by the following expression (3), for example.

$$[ Math . 3 ]$$

$${C}^{′} = \frac{{y}_{0} - {y}_{*}}{{x}_{0} - {x}_{*}} \qquad ( 3 )$$

With the next expression (4), the correction processing unit 19 uses the correction coefficient C′ to update a longitudinal position y (n) on the code tape 9 corresponding to the stop position on the nth floor of the building 2.

$$[ Math . 4 ]$$

$$y ( n ) = {y}_{0} - {C}^{′} ( {x}_{0} - x ( n ) ) \qquad ( 4 )$$

At this time, the control processing unit 18 controls the position of the car 7 by using the position y (n) on the code tape 9 corresponding to the nth floor as the target position of the longitudinal position y read by the reader 10 moving together with the car 7 for example, thereby stopping the car at the stop position on the floor.

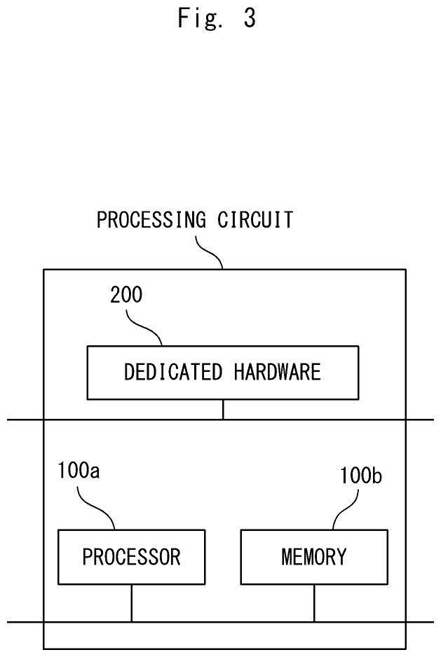

Subsequently, an example of a hardware configuration of the control system 8 will be described with reference to FIG. 3.

FIG. 3 is a hardware configuration diagram of a main part of the control system 8 according to Embodiment 1.

Each function of the control system 8 can be implemented by a processing circuit. The processing circuit includes at least one processor 100a and at least one memory 100b. The processing circuit may include, together with the processor 100a and the memory 100b, or in place of these components, at least one dedicated hardware 200.

In a case where the processing circuit includes the processor 100a and the memory 100b, functions of the control system 8 are implemented by software, firmware, or a combination of software and firmware. At least one of software and firmware is written as a program. The program is stored in the memory 100b. The processor 100a reads and executes the program stored in the memory 100b to implement the functions of the control system 8.

The processor 100a is also referred to as a central processing unit (CPU), a processing device, an arithmetic operation device, a microprocessor, a microcomputer, and a DSP. The memory 100b is configured of a nonvolatile or volatile semiconductor memory or the like such as a RAM, a ROM, a flash memory, an EPROM, an EEPROM, and the like, for example.

In a case where the processing circuit includes the dedicated hardware 200, the processing circuit is implemented by a single circuit, a complex circuit, a programmed processor, a processor subjected to parallel programming, an ASIC, an FPGA, or a combination of these components.

Each function of the control system 8 can be implemented by a processing circuit. Alternatively, the functions of the control system 8 can be collectively implemented by a processing circuit. It is also possible to implement some functions of the control system 8 by the dedicated hardware 200 and implement the other functions of the control system 8 by software or firmware. Thus, the processing circuit implements the functions of the control system 8 by the dedicated hardware 200, software, firmware, or a combination of these components.

### INDUSTRIAL APPLICABILITY

The control system according to the present disclosure is applicable to an elevator.

### REFERENCE SIGNS LIST

1 Elevator, 2 Building, 3 Hoistway, 4 Hall, 5 Traction machine, 6 Main rope, 7 Car, 8 Control system, 9 Code tape, 10 Reader, 11 Detection device, 12 Temperature sensor, 13 Controller, 14 Fixed end, 15 Movable end, 16 Detection target cam, 17 Detection switch, 18 Control processing unit, 19 Correction processing unit, 100a Processor, 100b Memory, 200 Dedicated hardware

1. An elevator control system comprising:
a code tape on which information indicating a longitudinal position is added over a longitudinal direction, placed such that the longitudinal direction is oriented in a vertical direction in a hoistway extending over a plurality of floors of a building, and including one end part in the vertical direction installed so as to be fixed to the hoistway as a fixed end and another end part in the vertical direction installed so as to be movable in the vertical direction relative to the hoistway as a movable end;
a reader that is installed in a car running through the hoistway in the vertical direction, and reads the information indicating the longitudinal position added to the code tape;
a detection device that includes a detection target body and a detector detecting the detection target body, one of the detection target body and the detector being installed in the car, another of the detection target body and the detector being installed in a reference position set in advance on the movable end side in the vertical direction of the hoistway, the detector detecting the detection target body to detect that the car is in the reference position; and
a controller that performs control processing of the car by using the longitudinal position read by the reader as an absolute position of the car in the vertical direction in the hoistway, and corrects the absolute position of the car by using the longitudinal position read by the reader when the detection device detects that the car is in the reference position.

2. The elevator control system according to claim 1, wherein
the reference position is set within a range from a stop position on a frequently stopped floor set in advance as a floor where the car stops more frequently than other floors to a stop position on an adjacent floor.

3. The elevator control system according to claim 1, wherein
the controller generates a call for the car to run through or to the reference position in a case where a current time satisfies a preset time condition.

4. The elevator control system according to claim 1 further comprising a temperature sensor installed in the hoistway, wherein
the controller generates a call for the car to run through or to the reference position in a case where a temperature measured by the temperature sensor satisfies a preset temperature condition.

5. The elevator control system according to claim 1, wherein
on condition that a speed of the car when running through the reference position is lower than a preset speed threshold, the controller corrects the absolute position of the car using the longitudinal position read by the reader when the detection device detects that the car is in the reference position in a case where the condition is satisfied.

6. The elevator control system according to claim 1, wherein
the controller calculates, as a correction coefficient, a ratio between a length from the fixed end to a part where the reader reads information indicating the longitudinal position when the detection device detects that the car is in the reference position and a length from an installation position of the fixed end to the reference position, and corrects the absolute position of the car using a value obtained by multiplying a length based on the fixed end by the correction coefficient.

7. The elevator control system according to claim 1, wherein
the controller judges whether an amount of change in the absolute position of the car corresponding to at least any of a stop position of each of the plurality of floors and the reference position before and after correction is within a preset allowable range, and corrects the absolute position of the car in a case where the change amount is within the allowable range.

8. The elevator control system according to claim 1, wherein
the controller judges whether an amount of change in the absolute position of the car corresponding to at least any of a stop position of each of the plurality of floors and the reference position before and after correction is within a preset allowable range, and judges that an abnormality has occurred in a case where the change amount is not within the allowable range.

9. The elevator control system according to claim 1, wherein
the controller judges whether an error of the absolute position of the car corresponding to at least any of a stop position of each of the plurality of floors and the reference position is within a preset allowable range, and corrects the absolute position of the car in a case where the error is within the allowable range.

10. The elevator control system according to claim 1, wherein
the controller judges whether an error of the absolute position of the car corresponding to at least any of a stop position of each of the plurality of floors and the reference position is within a preset allowable range, and judges that an abnormality has occurred in a case where the error is not within the allowable range.

11. The elevator control system according to claim 1, wherein
the fixed end is attached to a structure of the building, and
the one of the detection target body and the detector, which is installed in the reference position, is attached to the structure of the building.
